(19) United States
(12) Patent Application Publication
(10) Pub. No.: US 2025/0372103 A1
(43) Pub. Date: Dec. 4, 2025

(54) LARGE SCALE WIRELESS ACOUSTIC RECOGNITION NETWORK

(71) Applicant: NEC Laboratories America, Inc., Princeton, NJ (US)

(72) Inventors: Wataru KOHNO, PRINCETON, NJ (US); Jian FANG, PRINCETON, NJ (US); Ting WANG, WEST WINDSOR, NJ (US)

(73) Assignee: NEC Laboratories America, Inc., Princeton, NJ (US)

(21) Appl. No.: 19/219,965

(22) Filed: May 27, 2025

Related U.S. Application Data
(60) Provisional application No. 63/652,362, filed on May 28, 2024.

(51) Int. Cl. G10L 19/00

(52) U.S. Cl. CPC G10L 19/00

(57) ABSTRACT

A wireless acoustic sensor network with a compressed acoustic-language model/acoustic recognition model which is pretrained with a language model contrastive language-audio pretraining which involves two main components: an acoustic encoder and a text encoder which are trained on a large dataset of acoustic features and their textual captions. Inputting acoustic features or language generates embedding vectors. These vectors are linked in a joint latent space. Acoustic classification tasks involve assessing similarity between these embedding vectors. Users interact with the model using language input for classification. The architecture of this model permits the segregation of the pre-trained framework into distinct acoustic and text encoders, enabling their deployment across various devices, for instance, positioning the acoustic encoder on edge nodes and the text encoder on a central node.

### CROSS REFERENCE TO RELATED APPLICATIONS

This application claims the benefit of U.S. Provisional Patent Application Ser. No. 63/652,362 filed May 28, 2024, the entire contents of which is incorporated by reference as if set forth at length herein.

### FIELD OF THE INVENTION

This application relates generally to acoustic event recognition. More particularly, it pertains to acoustic recognition for the purposes of monitoring events.

### BACKGROUND OF THE INVENTION

As those skilled in the art will understand and appreciate, sound is a crucial element for understanding one's surroundings. Unusual sounds like explosions, sirens, and car alarms serve as auditory indicators of danger. Moreover, human activities such as transport, industrial production, operating large machinery or servers, and construction contribute to noise pollution, which poses risks to human health. Furthermore, not only humans but also certain animals such as birds and insects produce sounds, providing valuable insights into their distribution.

With advancements in Internet of Things (IoT) systems, the concept of Wireless Acoustic Sensor Networks (WASN) has emerged and been explored. In this concept, numerous wireless audio devices including microphones are deployed across wide geographic areas. Since directly listening to sounds from each microphone individually is impractical, the audio signals or acoustic information such as sound-pressure levels are transmitted to a central server and processed.

Sending audio data directly to a server imposes significant challenges, including (1) data size and (2) concerns about data privacy. For instance, a single channel audio recorded at a 48 kHz sampling rate with 16-bit depth for 10 seconds results in a file size of approximately 960 Kilobytes to 1 Megabyte. Consequently, and as will be readily appreciated, the complexity of the task increases with the number of sensors and the expansion of the monitored geographic area.

Additionally, with respect to privacy, centralizing and storing data onto a server can create discomfort as people fear that their conversations are being overheard and preserved electronically. Even if a server implements filters to eliminate human voices, this measure does not fully address public concerns, presenting further challenges to the acceptance and deployment of such audio devices.

Given these concerns, edge processing systems having an acoustic recognition model presents a promising solution to both data compression and privacy issues, and it has been one of the mainstreams of this domain. By analyzing acoustic features and categorizing audio data into specific events within a predetermined timeframe, such techniques can greatly reduce data volume while preserving important event-related information.

In operation, these techniques transform audio data into numerical values indicative of event types before it is directed to a server, which alleviates privacy worries since the transmitted data lacks any identifiable human voices or conversations. However, this approach is limited to predefined “event classes”, requiring the initial definition and fine-tuning of models.

Unfortunately, after these parameters are set, modifying, or updating them becomes challenging. Furthermore, once audio data is converted into event classes, delving into the specifics of “what actually happened” is difficult. For example, if “human voice” is an event class and the system detects one, users cannot further explore characteristics of the voice, such as whether it was screaming for help, singing, or determining gender. Expanding the model to a larger scale does not address the inherent limitation of predefined event classification and, in some cases, may complicate matters further if the system outputs “similar events in terms of sounds” that are “not relevant sounds”. For example, a system might incorrectly identify the sound as “fireworks” when it was, “gunshots”. This illustrates a significant challenge that acoustic recognition models cannot differentiate between sound events that are acoustically similar but contextually distinct

### SUMMARY OF THE INVENTION

An advance in the art is made according to aspects of the present disclosure directed to systems and methods that monitor events by acoustic recognition.

As illustratively configured, a wireless acoustic sensor network with a compressed acoustic-language model/acoustic recognition model which is pretrained with a language model contrastive language-audio pretraining which involves two main components: an acoustic encoder and a text encoder which are trained on a large dataset of acoustic features and their textual captions. Inputting acoustic features or language generates embedding vectors. These vectors are linked in a joint latent space.

Acoustic classification tasks involve assessing similarity between these embedding vectors. Users interact with the model using language input for classification. The architecture of this model permits the segregation of the pre-trained framework into distinct acoustic and text encoders, enabling their deployment across various devices, for instance, positioning the acoustic encoder on edge nodes and the text encoder on a central node.

The acoustic encoder is further optimized for compactness via methods like pruning, quantization, or knowledge distillation, making it suitable for integration into small-scale edge devices equipped with microphones. These devices capture acoustic signals resulting from various events, convert these signals into embedding vectors via the acoustic model, and then wirelessly forward these vectors to the central node with their device numbers. At the central node, these vectors are received, stored, and processed as dictated by the language-driven prompts from users

### BRIEF DESCRIPTION OF THE DRAWING

FIG. 1 is a schematic diagram showing an illustrative wireless acoustic sensor network with compressed acoustic-language model according to aspects of the present disclosure.

FIG. 2 is a schematic diagram showing illustrative architecture differences for wireless acoustic event recognition according to aspects of the present disclosure.

FIG. 3 is a schematic diagram showing illustrative indoor security application of our inventive systems and methods according to aspects of the present disclosure.

FIG. 4 shows in one illustrative example for prompt engineering of systems and methods according to aspects of the present disclosure.

FIG. 5 is a schematic diagram showing an illustrative system according to aspects of the present disclosure.

FIG. 6 shows an illustration for background vector subtraction scheme according to aspects of the present invention.

FIG. 7 shows results for acoustic event classification with background vector subtraction according to aspects of the present disclosure.

FIG. 8 shows classification results of ESC50 datasets with random changing prefixes according to aspects of the present disclosure.

FIG. 9 shows an illustrative feature diagram in hierarchical format for systems and methods according to aspects of the present disclosure.

FIG. 10 shows a schematic block diagram of an illustrative computer system in which certain aspects of the present disclosure may execute according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note again that sound is a crucial element for understanding our surroundings. Unusual sounds like explosions, sirens, and car alarms serve as auditory indicators of danger. Moreover, human activities such as transport, industrial production, operating large machinery or servers, and construction contribute to noise pollution, which poses risks to human health. Furthermore, not only humans but also certain animals (like birds) and insects (like cicadas) produce sounds, providing valuable insights into their distribution.

With advancements in IoT systems, the concept of Wireless Acoustic Sensor Networks (WASN) has emerged and been explored. In this concept, numerous wireless audio devices including microphones are deployed across wide areas. Since directly listening to sounds from each microphone one by one is impractical, the audio signals or acoustic information such as sound-pressure levels are transmitted to a server and processed.

Sending audio data directly to a server, however, imposes significant challenges, including (1) data size and (2) concerns about data privacy. For instance, a single channel audio recorded at a 48 kHz sampling rate with 16-bit depth for 10 seconds results in a file size of approximately 960 Kilo byte to 1 Megabyte. Consequently, the complexity of the task increases with the number of sensors and the expansion of the monitoring area.

With respect to privacy, centralizing and storing data onto a server can create discomfort, fearing that their conversations are being overheard. Even if the server implements filters to eliminate human voices, this measure does not fully address public concerns, presenting further challenges to the acceptance and deployment of such audio devices.

Under these concerns, edge processing with an acoustic recognition model presents a promising solution to both data compression and privacy issues, and it has been one of the mainstreams of this domain. By analyzing the acoustic features and categorizing audio data into specific events within a predetermined timeframe, this method can greatly reduce data volume while preserving important event-related information. This technique transforms audio data into numerical values indicative of event types before it is sent to the server, which alleviates privacy worries since the transmitted data lacks any identifiable human voices or conversations. However, this approach is limited to predefined “event classes”, requiring the initial definition and fine-tuning of models. After these parameters are set, modifying, or updating them becomes challenging. Furthermore, once audio data is converted into event classes, delving into the specifics of “what actually happened” is difficult.

For example, if “human voice” is an event class and the system detects it, users cannot further explore characteristics of the voice, such as whether it was screaming for help, singing, or determining gender. Expanding the model to a larger scale does not address the inherent limitation of predefined event classification and, in some cases, may complicate matters further if the system outputs “similar events in terms of sounds” that are “not relevant sounds”. For example, the system might incorrectly identify the sound as “fireworks” when it was “gunshots” in reality. This illustrates a significant challenge that acoustic recognition models cannot differentiate between sound events that are acoustically similar but contextually distinct.

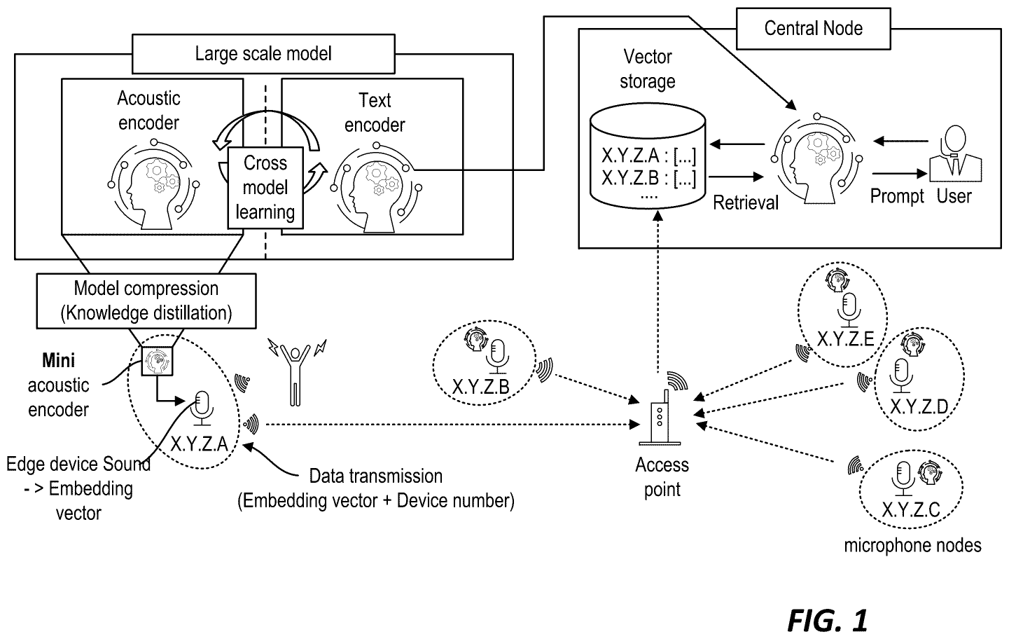

Our inventive systems and methods according to aspects of the present disclosure focuses on acoustic recognition for the purpose of monitoring events. The summary of the invention is depicted in FIG. 1, which is a schematic diagram showing an illustrative wireless acoustic sensor network with compressed acoustic-language model according to aspects of the present disclosure.

Accordingly, our inventive systems and methods include an acoustic recognition model which is pretrained with a language model. The pretraining method is called “contrastive language-audio pretraining”.

Contrastive language audio pretraining involves two main components: an acoustic encoder and a text encoder which are trained on a large dataset of acoustic features and their textual captions. Inputting acoustic features or language generates embedding vectors. These vectors are linked in a joint latent space.

Acoustic classification tasks involve assessing similarity between these embedding vectors. Users can interact with the model using language input for classification. The architecture of this model permits the segregation of the pre-trained framework into distinct acoustic and text encoders, enabling their deployment across various devices, for instance, positioning the acoustic encoder on edge nodes and the text encoder on a central node.

The acoustic encoder is further optimized for compactness via methods like pruning, quantization, or knowledge distillation, making it suitable for integration into small-scale edge devices equipped with microphones. These devices capture acoustic signals resulting from various events, convert these signals into embedding vectors via the acoustic model, and then wirelessly forward these vectors to the central node with their device numbers. At the central node, these vectors are received, stored, and processed as dictated by the language-driven prompts from users

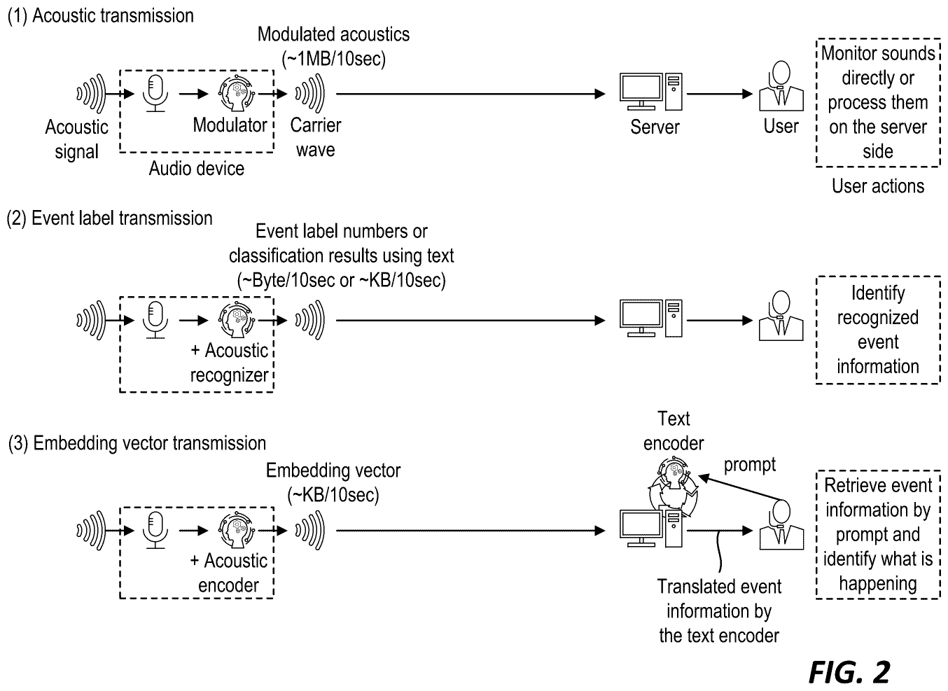

FIG. 2 is a schematic diagram showing illustrative architecture differences for wireless acoustic event recognition according to aspects of the present disclosure.

The summarized architectures for transmitting information regarding acoustic events in a Wireless Acoustic Sensor Network (WASN) are illustrated in FIG. 2, which outlines three distinct approaches.

The initial method involves directly streaming the acoustic data to the users. This raw data, approximately 1 Megabyte per 10 seconds, is modulated into carrier waves and sent to a central server. Here, users can either directly monitor the acoustic events or opt to process the data at the server level. While this approach is quite straightforward, it poses challenges related to the volume of data transferred and potential privacy issues.

The second method simplifies data transfer by transmitting only event labels or classification outcomes, which are derived from the original acoustic data by an acoustic recognizer. By converting the data into concise event labels, the data is dramatically compressed, often to of order 1 Byte. This allows users to discern the nature of the events from this minimized data. However, this approach restricts further event analysis and necessitates model refinement for updates or changes.

The third approach integrates an acoustic encoder within the edge device to generate “embedding vectors” composed of numerical representations of the acoustic data. These vectors, when transmitted to the central server, are further processed with a text encoder that has been jointly pretrained with the acoustic encoder through contrastive methods. Users interact with the system by providing prompts to the text encoder, which then decodes the embedding vectors into the acoustic events described in language

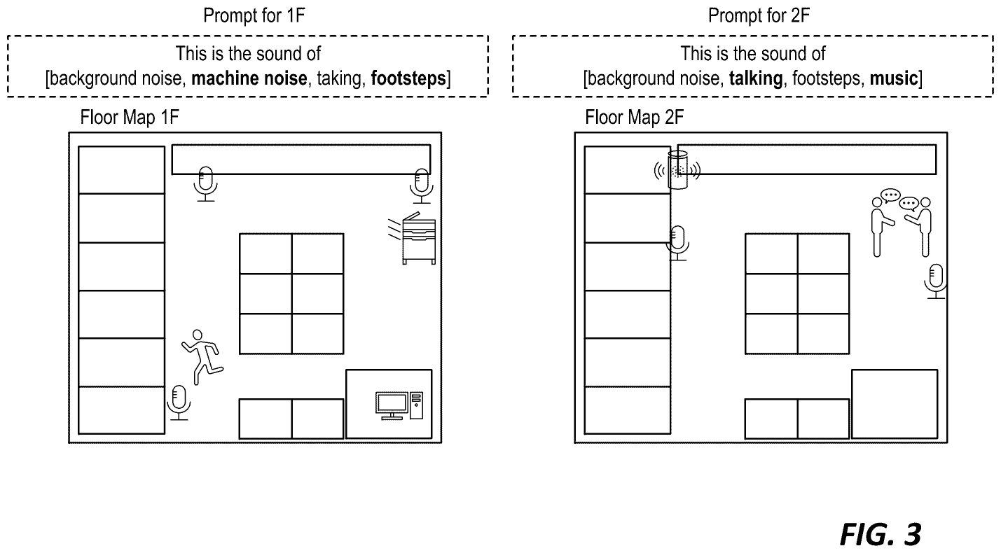

FIG. 3 is a schematic diagram showing illustrative indoor security application of our inventive systems and methods according to aspects of the present disclosure.

The third scheme, shown in FIG. 2., for wireless acoustic event recognition showcased in FIG. 3 highlights the system's adaptability for general users. This example illustrates the application for indoor security purposes, allowing users to specify which sounds to detect to grasp what is likely happening remotely.

For instance, if monitoring various floors with different acoustic events like the hum of machinery on one floor or background music on another users can tailor specific prompts for the acoustic recognition tasks to suit each environment's unique sounds. Additionally, it's feasible to customize the detection of events at the device level without modifying the acoustic encoder model. This capability enhances the system's versatility in accommodating diverse acoustic events

The embedding vectors received by the central server can be further refined to improve the precision of acoustic event predictions, with the simple vector calculations. For instance, if there is persistent, loud background noise near the device, the resultant acoustic embedding vectors may be heavily influenced by this noise. By identifying and subtracting this “background vector” from vectors containing additional acoustic events, it is feasible to isolate these other events. This process is akin to spectral subtraction, a technique used for noise reduction in acoustic signals, but it is possible to process on the central server side. It is also possible to recognize the acoustic event more accurately by designing users' prompt.

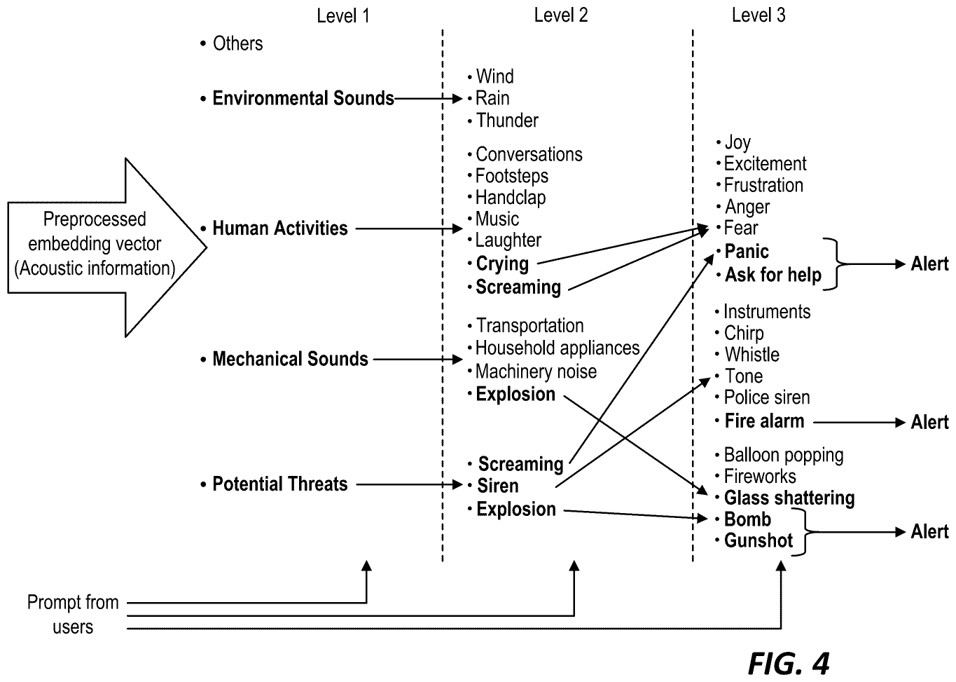

FIG. 4 shows in one illustrative example for prompt engineering of systems and methods according to aspects of the present disclosure. This FIG. 4 illustrates one of the examples for prompt designs utilizing multiple prompt layers. With this scheme, users can filter out irrelevant acoustic events effectively. Note that we don't need to modify the audio or text models themselves, just as one of the post processing for embedding vectors

This invention has specific features for large-scale acoustic events remotely and wirelessly, relating to issues in conventional ways listed in A1 as follows.

Substantial data compression: Acoustic data compression carried out on the edge device, making the audio data into other numerical series (embedding vectors), of order Kilobytes. This feature is essential for large-scale acoustic recognition in terms of difficulties in sending data to server side with a large number of edge devices.

Mitigation of data-privacy issue: Acoustic embedding vector contains not the raw or compressed audio data but the event information represented in vectors. Thus, once the edge devices just transform the audio data into the vectors, privacy issues are substantially mitigated.

Large-scale acoustic event mapping: Users can understand acoustic events happened around the edge devices in large scale, through the embedding-vector processing and event-map visualization.

Model flexibility for users: Users don't need to redefine and finetune the event classes for acoustic recognition.

Analysis for embedding vectors sent by edge devices: There remains a room to improve the accuracy for recognition by analyzing embedding vectors with some vector analysis (e.g., background vector subtraction) and prompt designs

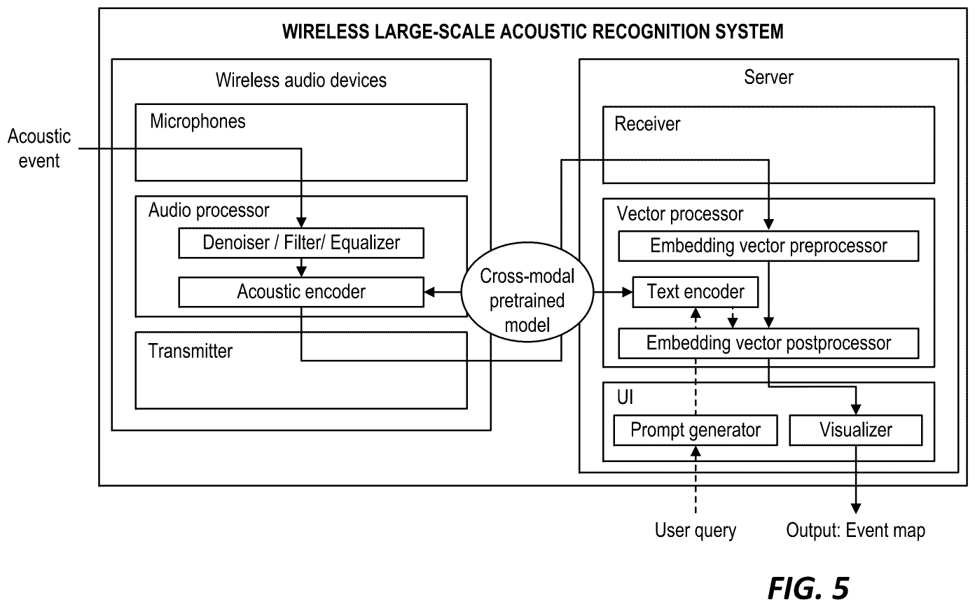

FIG. 5 is a schematic diagram showing an illustrative system according to aspects of the present disclosure.

FIG. 5 illustrates the structure of the proposed the invention, named wireless large-scale acoustic recognition system. This system has features that (1) records sounds and immediately into embedding vectors on the edge device by an acoustic encoder, (2) send the embedding vector and device number (e.g., IP address) wirelessly, (3) received the wireless signals at the central server, (4) process the embedding vectors to extract the acoustic-event information, and (5) visualize the results on an acoustic event map. They comprise edge (wireless audio devices) and central (Server) nodes. Each side has characteristic features described herein.

Wireless audio devices record acoustic signals, convert them into embedding vectors, and wirelessly transmit these vectors to the server side. The process is outlined below.

Microphones in edge devices: Acoustic signals are captured by audio devices, such as microphones. In underwater monitoring areas, these devices may be hydrophones.

Signal processing in audio processor 1: Detected audio signals undergo processing in denoisers (such as spectral subtraction, spectral gating), filters (including low-pass, high-pass, and band-pass filters), and equalizers (like graphic and parametric equalizers) within the processor to distill the acoustic features of events.

Signal processing in audio processor 2: The preprocessed audio data then passes through an acoustic encoder, which has been pretrained in conjunction with a text encoder contrastively. The encoder converts audio signals into an embedding vector. Although any acoustic encoder pretrained with the text encoder works, smaller models are preferable for real-time processing in compact edge devices without GPU resources.

Specifically, recent transformer-based acoustic models show high performance but are complex and have many parameters, resulting in longer processing times. For real-time, large-scale acoustic recognition with smaller models, knowledge distillation is effective, transferring capabilities from high-performing, complex transformer models to smaller, more efficient CNNs. With the acoustic encoder model, since teacher-model output is embedding vectors, student models learn from the embedding vector, i.e., it is not necessary to utilize caption information during knowledge distillation. In addition to knowledge distillation, conventional schemes such as model pruning and quantization also work for this purpose.

Transmission of embedding vectors by the transmitter: The processed embedding vectors and device identification numbers such as IP addresses are modulated onto carrier waves and wirelessly transmitted to the central server. Electromagnetic waves are typically used as the carrier medium for terrestrial environments. In contrast, acoustic signals serve as effective carriers for networks operating in underwater settings. In this situation, we need to choose an acoustic transducer as the transmitter.

Central server receives all the transmitted embedding vectors with device IP addresses, process the vectors, and visualize it on an acoustic event map based on prompts user generated. The detailed steps are described as follows.

Receive the embedding vectors by the receiver: The transmitted carrier signals are received and demodulated in the receiver.

Embedding vector processing in the vector processor 1: The received embedding vectors undergo preprocessing. Although these vectors solely represent acoustic features encoded into vector form, they can be manipulated, i.e., added or subtracted, due to their vector properties. For example, background noise subtraction significantly improves acoustic event classification accuracy.

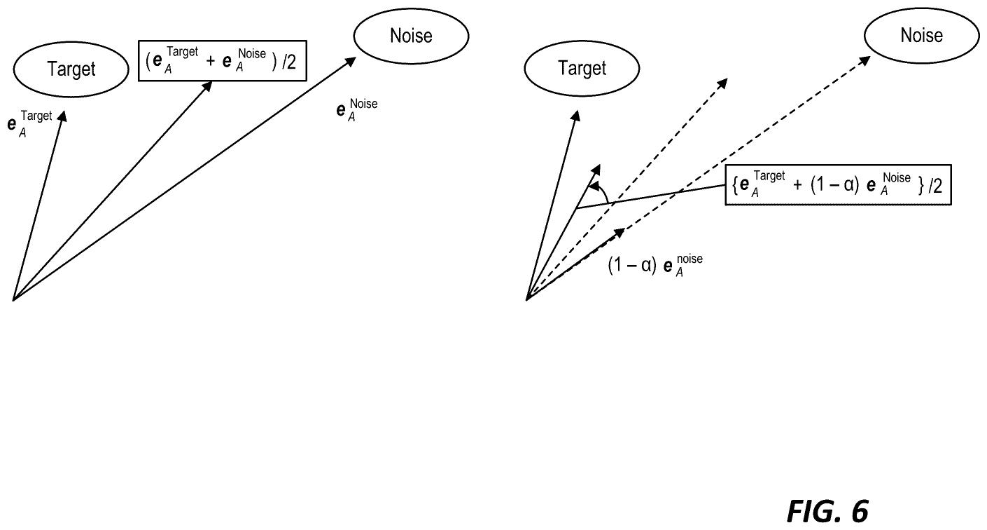

FIG. 6 shows an illustration for background vector subtraction scheme according to aspects of the present invention.

FIG. 6 briefly illustrates the concept of the background vector subtraction method. Subtracting a portion of noise from

$${e}_{A}^{Averaged}$$

rotates the vector towards the target, as depicted on the right side of FIG. 6. Hence, removing background components in vector space can enhance acoustic event classification analysis. In the noisy environment, especially because of stationary noise sources, the acoustic features included in the recorded audio signals are dominated by the noise. In this situation, assuming we collect

$${e}_{A}^{Noise}$$

from the background noise, the embedding vector

$${e}_{A}^{Recorded}$$

can be processed as

$${e}_{A}^{Denoised} ≡ {e}_{A}^{Recorded} - α {e}_{A}^{Noise} ,$$

where and α represents the coefficient for vector subtraction

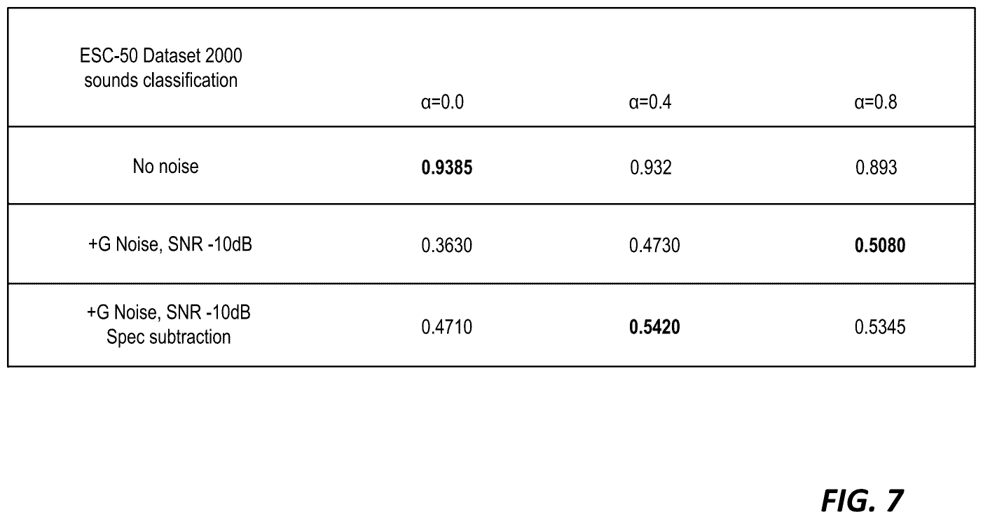

FIG. 7 shows results for acoustic event classification with background vector subtraction according to aspects of the present disclosure.

As may be observed, FIG. 7 presents the results of acoustic event classification using the ESC-50 dataset, which includes 2000 sound recordings categorized into 50 types of events (available on GitHub at karolpiczak/ESC-50). Shown is the effect of applying the background vector subtraction method to embedding vectors with varying coefficients of α. Since the dataset comprises audio recordings free of background noise, subtracting the vector does not enhance the results and may even decrease performance. However, when gaussian noise is added to the dataset, which yields substantial degradation for acoustic-event classification, the accuracy recovers with vector subtraction compared to when no subtraction is applied (i.e., α=0). This technique is beneficial even after denoising the raw audio signals, highlighting the utility of preprocessing embedding vectors

Embedding vector processing in the vector processor 2: In vector processor 2, the text encoder converts language-based prompts Pᵢ (i-th prompt) from the prompt generator into embedding vectors

$${e}_{T}^{{P}_{i}} .$$

These prompts are structured sentences specifying the event classes for classification. Typically, each prompt is structured with a “prefix”+“event class”+“postfix,” and the classification outcomes are influenced by the prompt's structure.

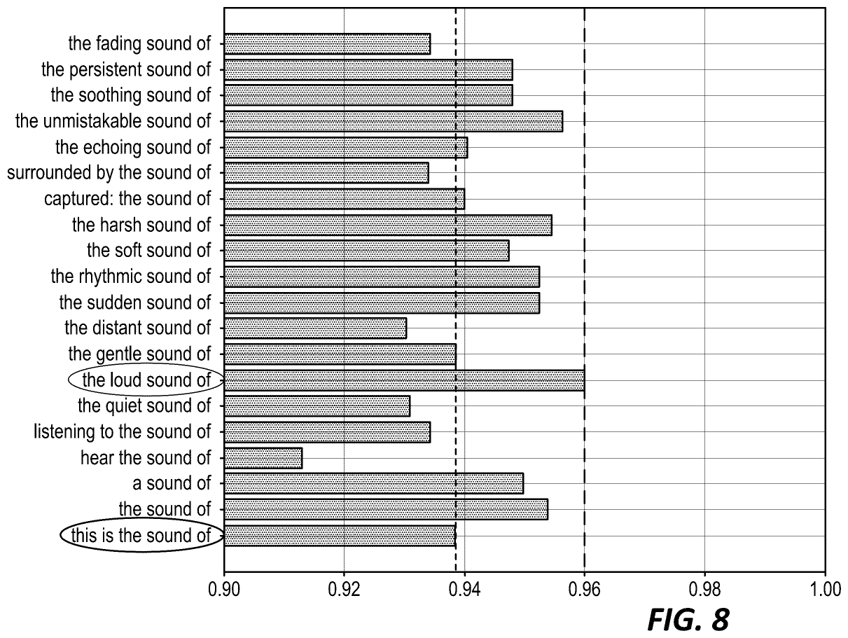

FIG. 8 shows classification results of ESC50 datasets with random changing prefixes according to aspects of the present disclosure.

FIG. 8 illustrates the impact of varying the prefix randomly; the results indicate that classification accuracy can be enhanced by up to 96%. Ensemble distributions from multiple prompts can increase robustness. This technique, known as prompt engineering, improves the precision of acoustic event predictions. Users can input prompts into the prompt generator, allowing them to customize their approach to acoustic event classification

In FIG. 4, the multi-layer recognition through the design of user prompts is described. Implementing this approach requires an iterative process for acoustic classification that cycles through prompt generators, the text encoder, an embedding post-processor, and a visualizer, where the iteration number corresponds to the number of layers.

Embedding vector processing in the vector processor 3: The preprocessed acoustic embedding vectors such as

$${e}_{A}^{Denoised}$$

and text embedding vectors

$${e}_{T}^{{P}_{i}}$$

are processed and transformed into the acoustic classification results. The classification is based on the evaluation of the similarity between these vectors, such as cosine similarity. The pair of acoustic and text embedding vectors with highest similarity is corresponding to the most-likely acoustic event described by the event class included in the prompt users set. The inference results based on vector-pair similarity with each device number is output to the visualizer in user interface.

Prompt generator: Within the prompt generator, large-scale language models (LLMs), like Generative Pre-trained Transformers (GPT), are utilized to interpret users' requests and convert them into a specific set of prompts, independent of the text encoder.

Acoustic-event visualizer: When a device is deployed at a specific spot, its number essentially signifies its position. Thus, the results of acoustic event classification alongside the device numbers are displayed on an acoustic map, akin to the map in FIG. 3. If users deploy edge devices randomly in a dispersed manner, integrating GPS into the devices allows for the transmission of both coordinates and device numbers. This method enables the visualization of the acoustic-event map with precise location data

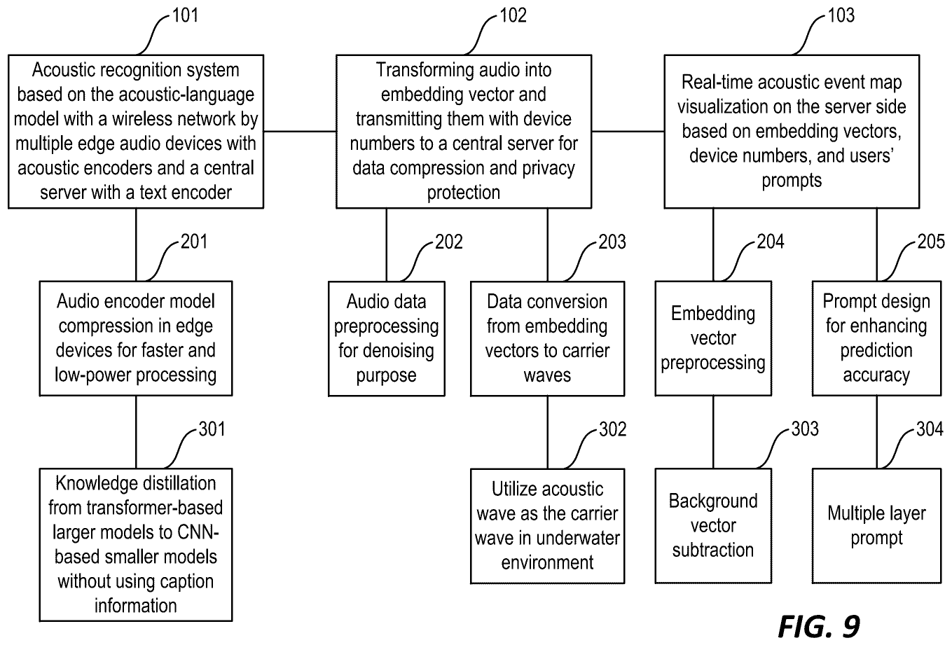

FIG. 9 shows an illustrative feature diagram in hierarchical format for systems and methods according to aspects of the present disclosure.

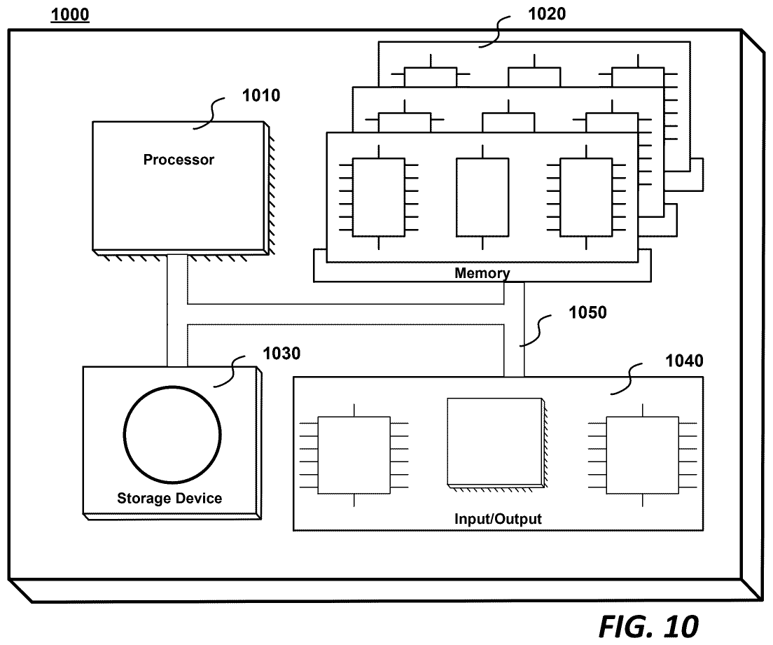

FIG. 10 shows a schematic block diagram of an illustrative computer system in which certain aspects of the present disclosure may execute according to aspects of the present disclosure.

As may be immediately appreciated, such a computer system may be integrated into another system such and may be implemented via discrete elements or one or more integrated components. The computer system may comprise, for example, a computer running any of a number of operating systems. The above-described methods of the present disclosure may be implemented on the computer system 1000 as stored program control instructions.

Computer system 1000 includes processor 1010, memory 1020, storage device 1030, and input/output structure 1040. One or more input/output devices may include a display 1045. One or more busses 1050 typically interconnect the components, 1010, 1020, 1030, and 1040. Processor 1010 may be a single or multi core. Additionally, the system may include accelerators etc., further comprising the system on a chip.

Processor 1010 executes instructions in which embodiments of the present disclosure may comprise steps described in one or more of the Drawing figures. Such instructions may be stored in memory 1020 or storage device 1030. Data and/or information may be received and output using one or more input/output devices.

Memory 1020 may store data and may be a computer-readable medium, such as volatile or non-volatile memory. Storage device 1030 may provide storage for system 1000 including for example, the previously described methods. In various aspects, storage device 1030 may be a flash memory device, a disk drive, an optical disk device, or a tape device employing magnetic, optical, or other recording technologies.

Input/output structures 1040 may provide input/output operations for system 1000.

At this point, those skilled in the art will understand and appreciate that we introduce a Deep Phase-Magnitude Network (DFMN) and point out that combining the filtering in time domain and frequency domain can significantly enhance the classification accuracy and improve the domain generalization ability. We divide the raw fiber sensing data into magnitude response and phase response for parallel feature representation learning. Furthermore, we propose a Phase Frequency Learnable Filter (PFLF) specifically designed for phase component learning, which effectively determines the frequency components crucial for enhancing rain detection accuracy. In the end, we formulate the phase-magnitude channel within a dual-path network and subsequently fuse the features for a comprehensive analysis. Extensive experiments and ablation studies demonstrate the effectiveness of our proposed method.

While we have presented our inventive concepts and description using specific examples, our invention is not so limited. Accordingly, the scope of our invention should be considered in view of the following claims.

1. A wireless acoustic recognition system comprising:
one or more wireless audio devices, configured to record acoustic signals, convert them into embedding vectors, and wirelessly transmit the vectors to a server, and
a server, configured to wirelessly receive all the transmitted embedding vectors with device IP addresses, process the vectors, and visualize events on an acoustic event map based on user generated prompts.

2. The system of claim 1 wherein the one or more wireless audio devices include one or more microphones or hydrophones which capture the acoustic signals.

3. The system of claim 2 wherein the one or more wireless audio devices include one or more of denoisers, filters, and equalizers which are configured to distill acoustic features of acoustic events.

4. The system of claim 3 wherein the one or more wireless audio devices include one or more acoustic encoders, which are pretrained in conjunction with a text encoder contrastively.

5. The system of claim 4 wherein the one or acoustic encoders are configured to covert audio signals into an embedding vector.
